(19) United States
(12) Patent Application Publication
(10) Pub. No.: US 2015/0200936 A1
(43) Pub. Date: Jul. 16, 2015

(54) SYSTEM AND METHOD FOR SECURITY AUTHENTICATION VIA MOBILE DEVICE

(71) Applicant: Electronics and Telecommunications Research Institute, Daejeon (KR)

(72) Inventors: Soo Hyung KIM, Daejeon (KR); Young Seob CHO, Daejeon (KR); Jong Hyouk NOH, Daejeon (KR); Jin Man CHO, Daejeon (KR); Sang Rae CHO, Daejeon (KR); Dae Seon CHOI, Daejeon (KR); Seung Hyun KIM, Daejeon (KR); Seok Hyun KIM, Daejeon (KR); Seung Hun JIN, Daejeon (KR)

(73) Assignee: Electronics and Telecommunications Research Institute, Daejeon (KR)

(21) Appl. No.: 14/337,881

(22) Filed: Jul. 22, 2014

(30) Foreign Application Priority Data
Jan. 10, 2014 (KR) 10-2014-0003451

(51) Int. Cl. H04L 29/06; H04W 12/06

(52) U.S. Cl. CPC H04L 63/0876; H04W 12/06

(57) ABSTRACT

Disclosed are a system for security authentication via a mobile device, which includes: a first terminal of a user which requests mobile authentication; a server which generates authentication information and a key for encryption, encrypts the authentication information with the key, and divides the key into first information and second information to transmit the first information to the first terminal and transmit the second information and the encrypted information to a second terminal of the user; and the second terminal which acquires the first information from the first terminal, generates the key based on the first information and the second information, and acquires the authentication information by using the generated key.

### CROSS-REFERENCE TO RELATED APPLICATIONS

This application claims priority to and the benefit of Korean Patent Application No. 10-2014-0003451 filed in the Korean Intellectual Property Office on Jan. 10, 2014, the entire contents of which are incorporated herein by reference.

### TECHNICAL FIELD

Various exemplary embodiments of the present invention relate to a system and a method for security authentication via a mobile device.

### BACKGROUND ART

Short message service (SMS) authentication is the technology that transmits authentication information to a user's portable terminal and thereafter, receives the authentication information from the user to authenticate a user. The SMS authentication is advantageous in that the user can be conveniently authenticated without possessing an additional authentication means or installing an application. Thus the SMS authentication is generally used for personal verification, a transaction approval, or security authentication such as in services including joining a website, an account transfer, micropayment system, signing in to a website (log-in), and the like.

However, the SMS authentication in the related art has a problem that the authentication information is transmitted to the user's portable terminal while the authentication information is not encrypted. Even though the authentication information is encrypted, the authentication information may be easily exposed to an attacker by an attack such as phishing, a vicious application, or the like due to weakness of management of a key for encryption, which is shared between a server and a user terminal.

### SUMMARY OF THE INVENTION

The present invention has been made in an effort to provide a system and a method for security authentication via a mobile device, having high security, which can solve problems that occur in the SMS authentication in the related art. The present invention has been made in an effort to further provide a computer readable recording medium having a program for executing the method in a computer, which is recorded therein. Technical objects to be achieved by various exemplary embodiments of the present invention are not limited to the technical objects as described above and other technical objects may be present.

An exemplary embodiment of the present invention provides a system for security authentication via a mobile device, including: a first terminal of a user which requests mobile authentication; a server which generates authentication information and a key for encryption in response to the request for the mobile authentication, encrypts the authentication information with the key, and divides the key into first information and second information to transmit the first information to the first terminal and transmit the second information and the encrypted information to a second terminal of the user different from the first terminal; and the second terminal of the user which acquires the first information from the first terminal, generates the key based on the first information and the second information, and acquires the authentication information by using the generated key.

The system may further include a third terminal which performs short-range wireless communication with the second terminal, and the server may transmit the second information and the encrypted information to the third terminal, and the second terminal may receive the second information and the encrypted information from the third terminal. Accordingly, authentication may be performed by using the third terminal of the user, which is an additional terminal to safely perform mobile authentication even when the second terminal of the user is lost or robbed or a vicious application is installed in the second terminal.

The third terminal may transfer the second information and the encrypted information to the second terminal through near field communication (NFC), Bluetooth, or WiFi when receiving the second information and the encrypted information from the server.

The system may further include a message server which transmits the second information and the encrypted information to the second terminal based on identification information received from the server, and the server may transmit the second information and the encrypted information to the second terminal through the message server.

The encrypted information may further include server information, and the second terminal may acquire the server information together with the authentication information by using the generated key and transmit the authentication information to the server by using the server information.

The encrypted information may further include an authentication purpose, and the second terminal may acquire the authentication purpose together with the authentication information by using the generated key and display the authentication information and the authentication purpose on a screen.

The second terminal may acquire an authentication purpose together with the authentication information by using the generated key, display the authentication purpose on the screen, and transmit the authentication information to the server when the user verifies the authentication purpose. Accordingly, the second terminal of the user may transmit the authentication information to the server without user's directly inputting the authentication information to increase user convenience and ensure safety even in advanced phishing such as an attack modifying part of a message.

Another exemplary embodiment of the present invention provides a method for security authentication via a mobile device, including: receiving, by a server performing mobile authentication, a request for mobile authentication from a first terminal of a user; generating, by the server, authentication information and a key for encryption in response to the request for the mobile authentication; encrypting, by the server, the authentication information with the key; dividing, by the server, the key into first information and second information; transmitting, by the server, the first information to the first terminal; and transmitting, by the server, the second information and the encrypted information to a second terminal of the user different from the first terminal.

Yet another exemplary embodiment of the present invention provides a method for security authentication via a mobile device, including: receiving, by a second terminal of a user, encrypted information and second information of a key for encryption from a server; acquiring, by the second terminal, first information of the key from a first terminal of the user which requests the server for mobile authentication; generating, by the second terminal, the key based on the first information and the second information; acquiring, by the second terminal, the authentication information by decrypting the encrypted information using the key; and transmitting, by the second terminal, the acquired authentication information to the server.

Still another exemplary embodiment of the present invention provides a computer readable recording medium having a program for executing the method for security authentication via a mobile device, which is recorded therein.

### BRIEF DESCRIPTION OF THE DRAWINGS

FIG. 1 is a configuration diagram of a system for security authentication via a mobile device according to an exemplary embodiment of the present invention.

FIG. 2 is a configuration diagram of a system for security authentication via a mobile device according to an exemplary embodiment of the present invention.

FIG. 3 is a configuration diagram of a system for security authentication via a mobile device according to an exemplary embodiment of the present invention.

FIG. 4 is a block diagram illustrating a configuration of a second terminal that performs mobile authentication according to the exemplary embodiment of the present invention.

FIG. 5 is a block diagram illustrating a configuration of a server that performs mobile authentication according to the exemplary embodiment of the present invention.

FIG. 6 illustrates an example of a screen of a first terminal that performs mobile authentication according to the exemplary embodiment of the present invention.

FIG. 7 illustrates an example of a screen of a second terminal that performs mobile authentication according to the exemplary embodiment of the present invention.

FIG. 8 is a flowchart for describing a method for security authentication via a mobile device according to an exemplary embodiment of the present invention.

FIG. 9 is a flowchart for describing a method for security authentication via a mobile device according to an exemplary embodiment of the present invention.

FIG. 10 is a flowchart for describing a method for security authentication via a mobile device according to an exemplary embodiment of the present invention.

### DETAILED DESCRIPTION

Hereinafter, various embodiments of the present invention will be described with reference to the drawings in detail. At this time, in each of the drawings, the same components are denoted by the same reference symbols, if possible. Further, detailed descriptions for the previously known features and/or configurations are omitted. In the description below, parts required to understand operations in accordance with various embodiments will be explained in priority, the descriptions for elements, which may obscure the gist of the descriptions, are omitted.

Also, in description for the embodiment of the present invention, terms such as first, second, A, B, (a), (b), etc. may be used. These terms are for distinguishing its components with other components merely, the nature, order, or sequence and the like of the component by the term is not limited.

FIG. 1 is a configuration diagram of a system for security authentication via a mobile device according to an exemplary embodiment of the present invention.

Referring to FIG. 1, the system for security authentication via a mobile device may include a first terminal 100, a second terminal 200, and a server 300.

The system for security authentication via a mobile device may generate authentication information and a key for encryption, and transmit encrypted information and the key, in response to a request for mobile authentication of a user. The mobile authentication system may approve the request for mobile authentication of the user based on received information in response to the transmission. For example, the mobile authentication system divides the key into first information and second information and transmits divided information on the key to different terminals of the user to perform the mobile authentication.

The mobile authentication system according to the exemplary embodiment may transmit the first information and the second information of the key generated in the server 300 to a first terminal 100 and a second terminal 200 of the user, respectively.

The first terminal 100 requests the server 300 to perform the mobile authentication. For example, the mobile authentication may include personal verification, a transaction approval, or security authentication such as joining a website, an account transfer, micropayment system, signing in to a website (log-in), and the like.

The first terminal 100 may receive the first information of the key generated in the server 300 in response to the request for mobile authentication of the user. According to the exemplary embodiment, the first terminal 100 may output the received first information in a format which may be acquired by the second terminal 200 or display the received first information on a screen.

According to the exemplary embodiment, the first terminal 100 may transmit and receive data to and from the server 300 through wired and wireless networks or wired serial communication. The network may include the Internet, a local area network (LAN), a wireless local area network (LAN), a wide area network (WAN), a personal area network (PAN), and the like.

For example, the first terminal 100 may include a personal computer (PC), a notebook computer, a cellular phone, a smart phone, a tablet, personal digital assistants (PDA), a portable multimedia player (PMP), a digital broadcasting terminal, a portable game terminal, a navigation system, and the like. However, the first terminal 100 is not limited thereto and the first terminal 100 may include all information communication devices, multimedia devices, and application devices thereof which may transmit and receive data to and from the server 300.

The second terminal 200 may be a terminal of the user different from the first terminal 100 of the user. The second terminal 200 may receive the second information of the key generated in the server 300 and the encrypted information in response to the request for mobile authentication of the user.

The second terminal 200 may acquire the first information of the key from the first terminal 100. According to an exemplary embodiment, the second terminal 200 photographs an image displayed on the screen of the first terminal 100 by using a camera provided in the second terminal 200 to acquire the first information from the first terminal 100. According to another exemplary embodiment, the second terminal 200 may acquire the first information from the first terminal 100 by using short-range wireless communication through a near field communication (NFC) touch or a Bluetooth connection button click.

The second terminal 200 may generate the key based on the first information and the second information of the key. The second terminal 200 decodes the encrypted information by using the generated key to acquire authentication information. According to an exemplary embodiment, the second terminal 200 may directly transmit the authentication information to the server 300 when the user verifies the authentication information. According to another exemplary embodiment, when the user inputs the authentication information displayed in the second terminal 200 into the first terminal 100, the first terminal 100 may transmit the authentication information to the server 300.

According to an exemplary embodiment, the second terminal 200 receives, through Internet connection with the server 300 or from the server 300, at least one of a short message service (SMS) message, a multimedia message service (MMS) message, and a push notification to receive the second information and the encrypted information.

The second terminal 200 according to the exemplary embodiment may be all terminals that may transmit and receive data to and from the server 300 through the wired and wireless networks or wired serial communication and acquire the first information from the first terminal 100.

According to the exemplary embodiment, the second terminal 200 may include a notebook computer, a cellular phone, a smart phone, a tablet, personal digital assistants (PDA), a portable multimedia player (PMP), a digital broadcasting terminal, a portable game terminal, a navigation system, and the like which are capable of performing mobile communication. However, the second terminal 200 is not limited thereto and the second terminal 200 may include all information communication devices, multimedia devices, and application devices thereof which may transmit and receive data to and from the server 300.

The server 300 may receive the request for the mobile authentication of the user from the first terminal 100. The server 300 generates the authentication information and the key for encryption in response to the request for the mobile authentication and encrypts the authentication information with the key. The authentication information may include numbers or character strings. For example, the server 300 may generate the encryption key for the authentication information whenever the authentication information is requested.

The server 300 divides the key into the first information and the second information to transmit divided information of the key. Accordingly, the server 300 may transmit the first information to the first terminal 100 and transmit the encrypted information including the authentication information and the second information to the second terminal 200 of the user.

The server 300 may approve the request for mobile authentication of the user based on information received from the first terminal 100 or the second terminal 200 in response to the transmission of the encrypted information, the first information, and the second information.

According to an exemplary embodiment, the server 300 may perform encryption on server information in addition to the authentication information and transmit the encrypted information to the second terminal 200. For example, the server information may include server URL or server session information. Accordingly, the second terminal 200 may acquire the server information together with the authentication information based on the encrypted information and the generated key and directly transmit the authentication information to the server 300 by using the acquired server information. Since the user need not directly input the authentication information, user convenience may be increased and an attack such as phishing, or the like while inputting the authentication information may be prevented.

According to another exemplary embodiment, the server 300 may perform the encryption on an authentication purpose in addition to the authentication information and transmit the encrypted information to the second terminal 200. Accordingly, the second terminal 200 acquires the authentication purpose together with the authentication information based on the encrypted information and the generated key to notify the authentication purpose to the user. For example, the second terminal 200 displays the authentication purpose together with the authentication information on the screen to allow the user to refer to the authentication purpose at the time of transmitting the authentication information to the server 300.

According to another exemplary embodiment, the second terminal 200 may acquire the authentication information and the authentication purpose included in the encrypted information by using the generated key and display only the authentication purpose on the screen. For example, when the user verifies the authentication purpose, the second terminal 200 may allow the authentication information to be automatically transmitted to the server 300.

As described above, the system for security authentication via a mobile device includes the authentication purpose in the encrypted information and transmits the authentication purpose together with the authentication information to prevent the user from performing authentication for another purpose unconsciously.

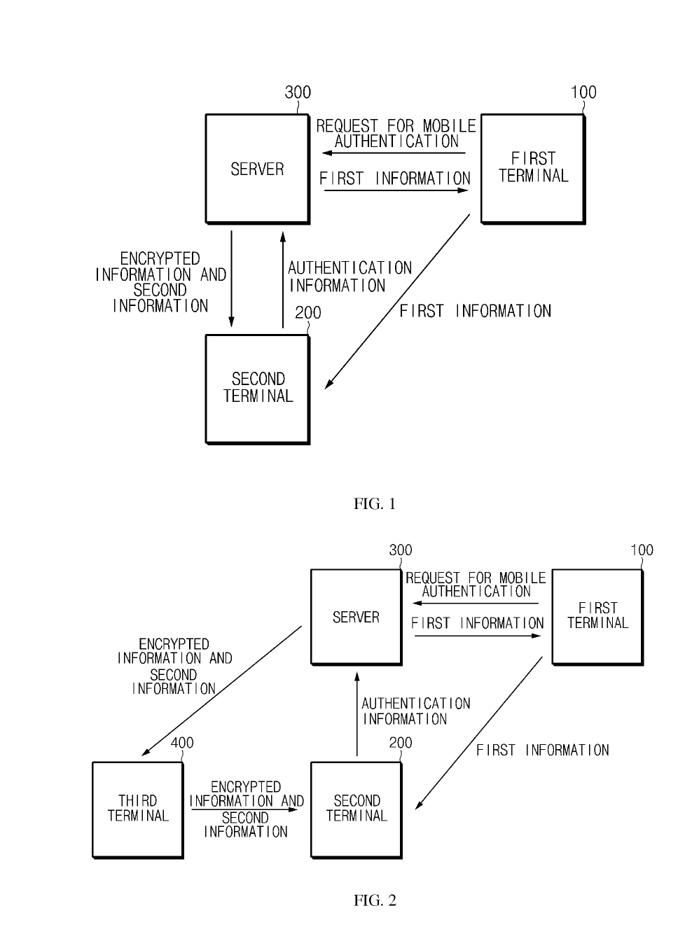

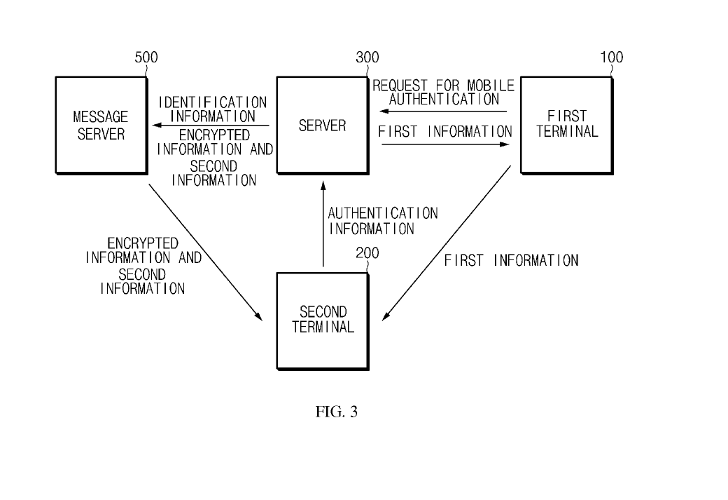

FIG. 2 is a configuration diagram of a system for security authentication via a mobile device according to an exemplary embodiment of the present invention.

Referring to FIG. 2, the system for security authentication via a mobile device may include a first terminal 100, a second terminal 200, a third terminal 400, and a server 300.

The system for security authentication via a mobile device of FIG. 2 divides a key generated in response to the request for the mobile authentication of the user into first information and second information and transmits divided information on the key to respective different terminals of the user to perform the mobile authentication, similarly as the system for security authentication via a mobile device of FIG. 1.

The system for security authentication via a mobile device according to the exemplary embodiment performs the mobile authentication by further using the third terminal 400 of the user in addition to the first terminal 100 and the second terminal 200 of the user.

The first terminal 100 requests the server 300 to perform the mobile authentication. The first terminal 100 may receive the first information of the key generated in the server 300 in response to the request for mobile authentication of the user. According to an exemplary embodiment, the first terminal 100 may output the received first information in a format which may be acquired by the second terminal 200 or display the received first information on a screen.

According to the exemplary embodiment, the first terminal 100 may be a terminal that may transmit and receive data to and from the server 300 through the wired and wireless networks or the wired serial communication. For example, the first terminal 100 may include a personal computer (PC), a notebook computer, a cellular phone, a smart phone, a tablet, personal digital assistants (PDA), a portable multimedia player (PMP), a digital broadcasting terminal, a portable game terminal, a navigation system, and the like.

The second terminal 200 may be a terminal of the user different from the first terminal 100 and the third terminal 400 of the user. The second terminal 200 may acquire the first information of the key from the first terminal 100 and receive the second information and the encrypted information from the third terminal 400 of the user. For example the second terminal 200 may acquire the first information from the first terminal 100 by using camera photographing, a near field communication (NFC) touch, a Bluetooth connection button click, or a WiFi connection button click.

According to an exemplary embodiment, the second terminal 200 may receive the second information and the encrypted information from the third terminal 400 through short-range wireless communication with the third terminal 400. A short-range wireless technology may include Bluetooth, radio frequency identification (RFID), infrared data association (IrDA), an ultra wideband (UWB), a ZigBee, Wi-Fi direct (WFD) near field communication (NFC), and the like.

The second terminal 200 may generate the key based on the first information and the second information of the key. The second terminal 200 decodes the encrypted information by using the generated key to acquire authentication information.

The third terminal 400 may receive the second information and the encrypted information from the server 300 and transmit the received second information and encrypted information to the second terminal 200. For example, the third terminal 400 receives, through Internet connection with the server 300 or from the server 300, at least one of a short message service (SMS) message, a multimedia message service (MMS) message, and a push notification to receive the second information and the encrypted information.

The third terminal 400 may transmit the second information and the encrypted information to the second terminal 200 through the near field communication (NFC), the Bluetooth, or the Wi-Fi. However, the third terminal 400 is not limited thereto and the third terminal 400 may perform communication with the second terminal 200 through various other communication methods.

For example, the second terminal 200 may be connected to the third terminal 400. Accordingly, when the third terminal 400 receives the second information and the encrypted information from the server 300, the third terminal 400 may set the second information and the encrypted information to be transferred to the second terminal 200.

The second terminal 200 according to the exemplary embodiment may include all terminals that may perform short-range wireless communication with the third terminal 400 and may acquire the first information from the first terminal 100. The third terminal 400 may include all terminals that may perform short-range wireless communication with the second terminal 200 and may acquire the second information and the encrypted information from the server 300.

According to an exemplary embodiment, any one of the second terminal 200 and the third terminal 400 may be various types of wearable electronic devices including a smart watch, a smart glass, an electronic bracelet, an electronic anklet, an electronic necklace, an electronic ring, an electronic belt, and the like, and the other may be a device coupled with the wearable electronic devices including a notebook computer, a cellular phone, a smart phone, a tablet, personal digital assistants (PDA), a portable multimedia player (PMP), a digital broadcasting terminal, a portable game terminal, a navigation system, and the like.

However, the second terminal 200 and the third terminal 400 are not limited thereto and the second terminal 200 and the third terminal 400 may include all information communication devices, multimedia devices, and application devices thereof which may connect with each other and may transmit and receive data to and from the server 300.

The server 300 receives the request for the mobile authentication of the user from the first terminal 100, generates the authentication information and the encryption key in response to the request for the mobile authentication, and encrypts the authentication information with the key.

The server 300 divides the key into the first information and the second information to transmit divided information of the key. In the exemplary embodiment, the server 300 may transmit the first information to the first terminal 100 and transmit the encrypted information including the second information and the authentication information to the third terminal 400 of the user.

The server 300 may approve the request for mobile authentication of the user based on information received from the first terminal 100 or the second terminal 200 in response to the transmission of the encrypted information, the first information, and the second information.

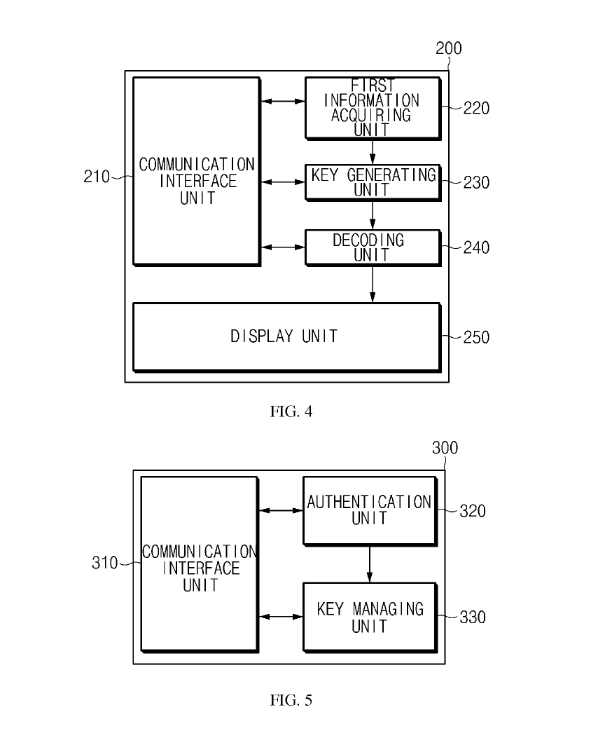

FIG. 3 is a configuration diagram of a system for security authentication via a mobile device according to an exemplary embodiment of the present invention.

Referring to FIG. 3, the system for security authentication via a mobile device may include a first terminal 100, a second terminal 200, a server 300, and a message server 500.

The system for security authentication via a mobile device of FIG. 3 divides the key generated in response to the request for the mobile authentication of the user into first information and second information and transmits divided information on the key to respective different terminals of the user to perform the mobile authentication, similarly as the system for security authentication via a mobile device of FIG. 1.

In the system for security authentication via a mobile device according to the exemplary embodiment, the server 300 transmits the first information to the first terminal 100, and the encrypted information and the second information to the second terminal 200 of the user through the message server 500.

The first terminal 100 requests the server 300 to perform the mobile authentication. For example, the first terminal 100 may transmit identification information to the server 300 when the mobile authentication is requested. For example, the identification information may include an ID, a phone number, or an e-mail. The first terminal 100 receives the first information of the key generated in the server 300 in response to the request for mobile authentication of the user.

The second terminal 200 is a terminal of the user different from the first terminal 100 of the user. The second terminal 200 may acquire the first information of the key from the first terminal 100 and receive the second information and the encrypted information from the message server 500. For example, the second terminal 200 receives the second information and the encrypted information from the message server 500, by using at least one of a short message service (SMS) message, a multimedia message service (MMS) message, and a push notification.

The second terminal 200 may generate the key based on the first information and the second information of the key. The second terminal 200 decodes the encrypted information by using the generated key to acquire authentication information.

The server 300 may receive the request for the mobile authentication of the user from the first terminal 100. For example, the server 300 may further receive the identification information from the first terminal 100.

According to an exemplary embodiment, the server 300 may receive a phone number or an e-mail of the second terminal 200 to which the encrypted information including the authentication information is transmitted from the first terminal 100.

According to another exemplary embodiment, the server 300 may receive a user ID from the first terminal 100. The server 300 may retrieve the phone number or e-mail of the second terminal 200 of the user based on the received ID by referring to a memory storing user information, and the like.

According to another exemplary embodiment, the message server 500 that stores the user information corresponding to the user ID receives the ID from the server 300 to retrieve the phone number or e-mail of the second terminal 200 of the user.

The server 300 generates the authentication information and the encryption key, and divides the key into first information and second information to transmit divided information of the key. Accordingly, the server 300 transmits the first information to the first terminal 100. The server 300 may transmit the second information and the encrypted information to the message server 500 together with the identification information of the user. The server 300 according to the exemplary embodiment may transmit the second information and the encrypted information to the second terminal 200 through the message server 500.

The server 300 may approve the request for mobile authentication of the user based on information received from the first terminal 100 or the second terminal 200 in response to the transmission of the encrypted information, the first information, and the second information.

The message server 500 may transmit the second information and the encrypted information to the second terminal 200 by using the identification information received from the server 300.

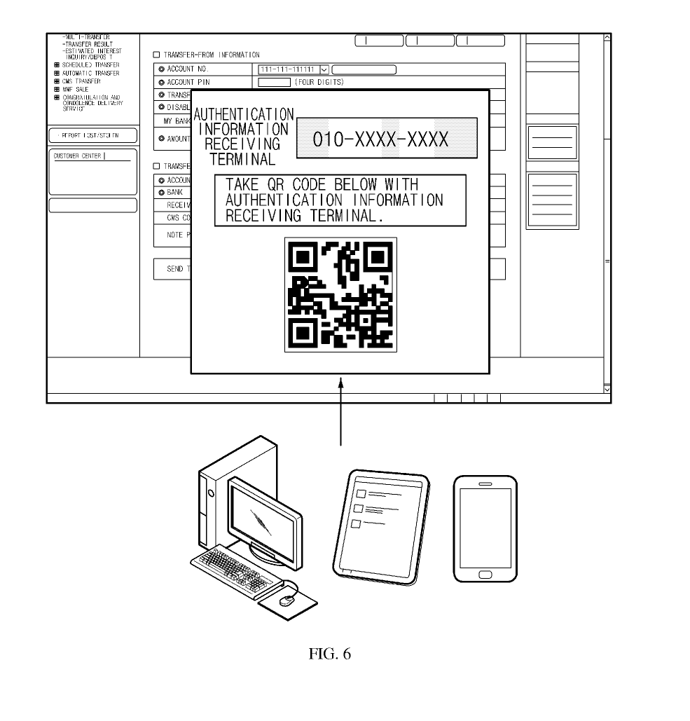

FIG. 4 is a block diagram illustrating a configuration of a second terminal that performs mobile authentication according to the exemplary embodiment of the present invention. The second terminal 200 according to the exemplary embodiment may be applied to the second terminal 200 illustrated in FIGS. 1 to 3.

The second terminal 200 is an authentication information receiving terminal that acquires the authentication information based on the encrypted information, and the first information and the second information of the key. Referring to FIG. 4, the second terminal 200 may include a communication interface unit 210, a first information acquiring unit 220, a key generating unit 230, a decoding unit 240, and a display unit 250.

The second terminal 200 as a terminal different from the first terminal 100 of the user that requests the mobile authentication may receive the second information of the key generated in the server 300 and the encrypted information in response to the request for the mobile authentication of the user.

The communication interface unit 210 may receive the second information of the key and the encrypted information from the server 300 through the third terminal 400 of the user or the message server 500. The communication interface unit 210 may transmit the authentication information acquired by the decoding unit 240 to the server 300. According to an exemplary embodiment, when the encrypted information further includes the server information together with the authentication information, the decoding unit 240 may acquire the server information together with the authentication information by using the generated key and the communication interface unit 210 may transmit the authentication information to the server 300 by using the acquired server information.

The communication interface unit 210 may transmit and receive data through the wired and wireless networks or wired serial communication. For example, the network includes the Internet, the local area network (LAN), the wireless local area network (LAN), a wide area network (WAN), a personal area network (PAN), and the like, but is not limited thereto and those skilled in the art to which the exemplary embodiment pertains may know that the network may be a network of a different type that may transmit and receive information.

The communication interface unit 210 may perform message transmission/reception functions including the short message service (SMS)/multimedia message service (MMS), e-mail and push notification, and the like, an Internet access function, and a social network service (SNS) function through the communication network.

According to an exemplary embodiment, the communication interface unit 210 may connect with the first terminal 100, the third terminal 400, or other electronic devices by using the short-range wireless technology. The short-range wireless technology according to the exemplary embodiment may include Bluetooth, radio frequency identification (RFID), infrared data association (IrDA), an ultra wideband (UWB), ZigBee, Wi-Fi direct (WFD) near field communication (NFC), and the like.

The first information acquiring unit 220 acquires the first information from the first terminal 100. For example, when the second terminal 200 acquires the first information through camera photographing, the first information acquiring unit 220 may further include a camera module which performs the camera photographing and an image processing module which acquires the first information by processing an acquired image. Alternatively, when the second terminal 200 acquires the first information through Bluetooth connection, the first information acquiring unit 220 may include a Bluetooth module. For example, the first information acquiring unit 220 may be included in the communication interface unit 210.

According to various exemplary embodiments, the first information acquiring unit 220 may acquire the first information from the first terminal 100 by using camera photographing, a near field communication (NFC) touch, a Bluetooth connection button click, or a WiFi connection button click.

The key generating unit 230 generates the key based on the first information and the second information. The key generating unit 230 may receive the second information of the key through the communication interface unit 210 and acquire the first information through the first information acquiring unit 220. For example, the key generating unit 230 may generate the key using a key generation function having the first information and the second information as inputs. The key generation function, for example, may include an arithmetic operation or a logic operation. Or, the key generating unit 230 may generate the key by performing a task such as attachment of the first information and the second information.

The decoding unit 240 may acquire the authentication information by using the key generated by the key generating unit 230.

According to an exemplary embodiment, when the encrypted information further includes the server information in addition to the authentication information, the decoding unit 240 may acquire the server information together with the authentication information.

According to another exemplary embodiment, when the encrypted information further includes an authentication purpose in addition to the authentication information, the decoding unit 240 may acquire the authentication purpose together with the authentication information.

The display unit 250 may display the acquired server information on the screen. The display unit 250 according to the exemplary embodiment may include at least one of a liquid crystal display (LCD), a thin film transistor LCD (TFT LCD), a light emitting diode (LED), an organic LED (OLED), an active matrix OLED (AMOLED), a flexible display, a bended display, and a 3D display. Some displays among them may be implemented by transparent displays configured by a transparent type or an optical transparent type so as to view the outside.

According to an exemplary embodiment, when the encrypted information further includes the authentication purpose in addition to the authentication information, the display unit 250 may display the authentication purpose together with the authentication information or display only the authentication purpose on the screen.

FIG. 5 is a block diagram illustrating a configuration of a server that performs mobile authentication according to the exemplary embodiment of the present invention. The server 300 according to the exemplary embodiment may be applied to the server 300 illustrated in FIGS. 1 to 4.

Referring to FIG. 5, the server 300 may include a communication interface unit 310, an authentication unit 320, and a key managing unit 330. The server 300 may perform mobile authentication in response to a request for the mobile authentication of a user. The server 300 may generate authentication information and a key for encryption.

The communication interface unit 310 may receive the request for the mobile authentication from the first terminal 100 of the user. According to an exemplary embodiment, the communication interface unit 310 may further receive identification information from the first terminal 100.

The communication interface unit 310 may transmit first information generated in the key managing unit 330 to the first terminal.

The communication interface unit 310 may transmit second information generated by the key managing unit 330 and encrypted information generated by the authentication unit 320 to the second terminal 200 or the third terminal 400 of the user different from the first terminal 100 or the message server 500. According to an exemplary embodiment, the communication interface unit 310 may further transmit the identification information the message server 500.

The communication interface unit 310 may transmit and receive data through the wired and wireless networks or wired serial communication. For example, the network includes Internet, a local area network (LAN), a wireless local area network (LAN), a wide area network (WAN), a personal area network (PAN), and the like, but is not limited thereto and those skilled in the art to which the exemplary embodiment pertains may know that the network may be a network of a different type that may transmit and receive information.

The communication interface unit 310 may further perform the message transmission/reception functions including the short message service (SMS)/multimedia message service (MMS), the e-mail and push notification, and the like through the communication network.

The authentication unit 320 may generate the authentication information in response to the request for the mobile authentication.

The authentication unit 320 receives the key generated by the key managing unit 330 to encrypt the authentication information with the key. The authentication unit 320 sends the encrypted information to the communication interface unit 310. According to an exemplary embodiment, the authentication unit 320 may encrypt at least one of the server information and the authentication purpose together with the authentication information with the key.

The authentication unit 320 may receive the authentication information from the first terminal 100 or the second terminal 200 and perform authentication processing of the mobile authentication of the first terminal 100 based on the received authentication information.

The authentication unit 320 may approve the request for the mobile authentication when the authentication information generated by the authentication unit 320 and the authentication information received from the first terminal 100 or the second terminal 200 are the same as each other.

The key managing unit 330 may generate the encryption key in response to the request for the mobile authentication. The key managing unit 330 may divide the key into first information and second information. The key managing unit 330 sends to the communication interface unit 310 the first information and the second information which are divided information on the key.

FIG. 6 illustrates an example of a screen of a first terminal that performs mobile authentication according to the exemplary embodiment of the present invention.

The first terminal 100 may transmit the request for the mobile authentication to the server 300. For example, the mobile authentication may include personal verification, a transaction approval, or security authentication such as joining a website, an account transfer, micropayment system, signing in to a website (log-in), and the like. In the exemplary embodiment, it will be described as an example that a user performs authentication of an online banking account transfer.

The user may access a website for online banking of a bank through the first terminal 100 and request the mobile authentication of the account transfer on the website. For example, the user may request the mobile authentication of the account transfer on a website screen illustrated in FIG. 6. When requesting the mobile authentication, the user may directly input the identification information for receiving the authentication information. Alternatively, user identification information which is preregistered in the corresponding website may be used. The identification information may be a user ID, or a phone number or an e-mail address of the second terminal 200 or the third terminal 400.

The server 300 of the website of the online banking generates the authentication information and the encryption key in response to the request for the mobile authentication of the user. For example, the server 300 may generate the encryption key for the authentication information whenever the authentication information is requested. Accordingly, the server 300 generates different authentication information and encryption key each time. The server 300 encrypts the generated authentication information with the generated key. For example, the server 300 encrypts the authentication purpose or the server information in addition to the authentication information. The server 300 may divide the key into the first information and the second information, and the first information may be transmitted to the first terminal 100 of the user and the encrypted information and the second information may be transmitted to the second terminal 200 or the third terminal 400 of the user, or the message server 500. The server 300 may transmit the encrypted information and the second information to the second terminal 200 or the third terminal 400 of the user by using the identification information.

The first terminal 100 receives the first information of the key from the server 300. The first terminal 100 may output the received first information in a format which may be acquired by the second terminal 200 or display the received first information on the screen. For example, the first terminal 100 may output the first information to the second terminal 200 through near field communication (NFC), Bluetooth, or WiFi connection or display the first information on the screen so that the second terminal 200 acquires the first information through camera photographing.

According to an exemplary embodiment, the first terminal 100 may display the first information received from the server 300 on the screen in a quick response code (QR code) format as illustrated in FIG. 6. Besides, the first terminal 100 receives the first information of the key from the server 300 to display the received information on the screen in a bar code format.

For example, the first terminal 100 may display the first information on the screen in the QR code format and the user may instruct the second terminal 200 that acquires the authentication information to photograph a QR code.

The first terminal 100 according to the exemplary embodiment may include a personal computer (PC), a notebook computer, a cellular phone, a smart phone, a tablet, personal digital assistants (PDA), a portable multimedia player (PMP), a digital broadcasting terminal, a portable game terminal, a navigation system, and the like.

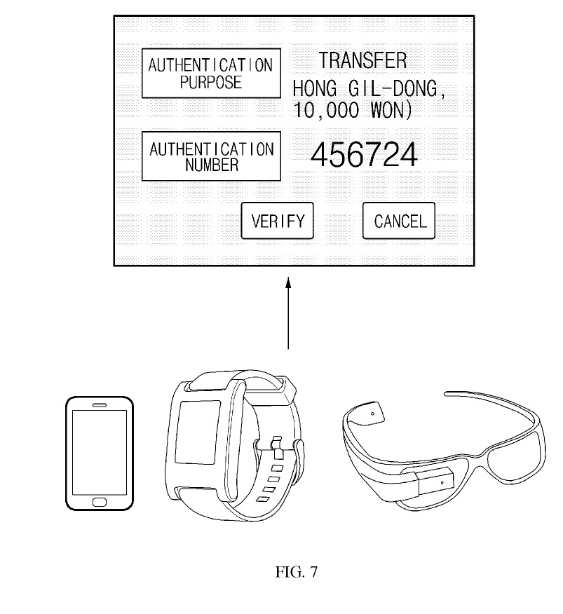

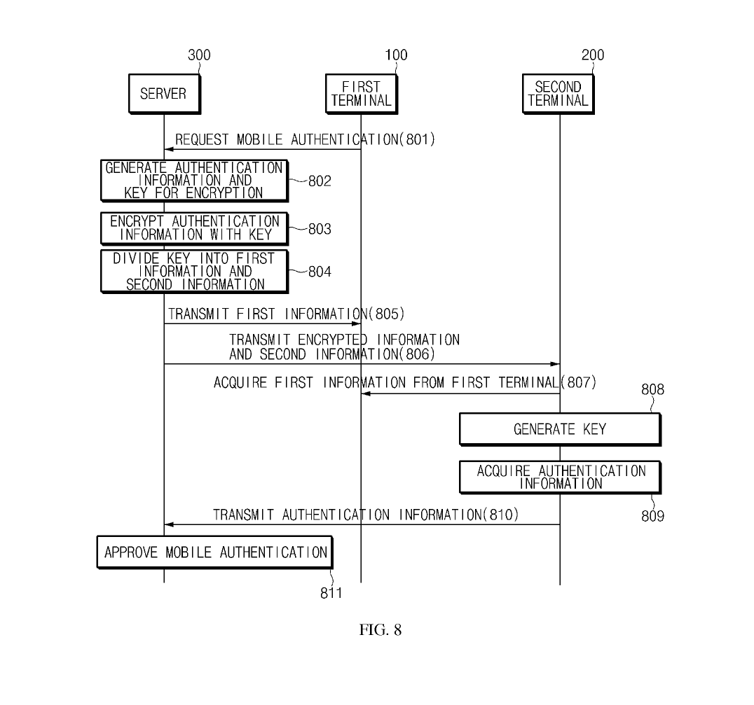

FIG. 7 illustrates an example of a screen of the second terminal that performs mobile authentication according to the exemplary embodiment of the present invention.

The second terminal 200 may acquire the first information from the first terminal 100 and receive the second information and the encrypted information from the server 300 through the third terminal 400 of the user or the message server 500, and acquire the authentication information based on the acquired and received information.

When it will be described as an example that the user performs the authentication of the online banking account transfer, the server 300 of the website of the online banking generates the authentication information and the encryption key in response to the request for the mobile authentication of the user. The server 300 encrypts the generated authentication information with the generated key and divides the key into the first information and the second information. The server 300 may transmit the first information to the first terminal 100 of the user, and the encrypted information and the second information to the second terminal 200, or the third terminal 400 of the user, or the message server 500.

The second terminal 200 may receive the encrypted information and the second information directly from the server 300 or through the message server 500 or the third terminal 400. When the second terminal 200 receives the second information and the encrypted information from the server 300 or the message server 500, the second terminal 200 may receive at least one of the short message service (SMS) message, the multimedia message service (MMS) message, and the push alarm through Internet connection with the server 300 or the message server 500 or from the server 300 or the message server 500.

When the second terminal 200 receives the second information and the encrypted information from the third terminal 400, the second terminal 200 may receive the second information and the encrypted information through near field communication (NFC), Bluetooth, or Wi-Fi communication with the third terminal 400. However, the second terminal 200 is not limited thereto and the second terminal 200 may receive the second information and the encrypted information from the third terminal 400 through radio frequency identification (RFID), infrared data association (IrDA), ultra wideband (UWB), ZigBee, and the like.

The second terminal 200 acquires the first information from the first terminal 100. For example, the second terminal 200 may request the user to acquire the QR code output to the first terminal 100. For example, the second terminal 200 may acquire the first information from the first terminal 100 by using camera photographing, a near field communication (NFC) touch, a Bluetooth connection button click, or a WiFi connection button click.

According to an exemplary embodiment, the second terminal 200 may photograph the QR code of the first information displayed in the first terminal 100 illustrated in FIG. 6 by using a camera. The second terminal 200 may acquire the first information by reading the photographed QR code.

As described above, when the second terminal 200 acquires the first information and the second information of the key, the second terminal 200 may generate the key and decode the encrypted information. When the encrypted information further includes the authentication purpose in addition to the authentication information, the second terminal 200 may display the authentication purpose together with the authentication information or only the authentication purpose on the screen. For example, the second terminal 200 may display on the screen an authentication purpose that 10,000 won is transferred to Hong Gil-dong, as illustrated in FIG. 7. In FIG. 7, an authentication number corresponding to the authentication information may also be displayed together with the authentication purpose According to an exemplary embodiment, the second terminal 200 may display only the authentication purpose on the screen.

The user verifies the displayed authentication purpose and presses a ‘VERIFY’ button or the user presses a ‘CANCEL’ to cancel the authentication when the displayed authentication purpose is different from the authentication purpose requested by the user. As described above, when the user verifies the authentication purpose, the second terminal 200 may transmit the authentication information to the server 300 of the website of the online banking. Alternatively, the user directly inputs the authentication number in the first terminal 100, and thus, the authentication information may be transmitted from the first terminal 100 to the server 300.

The server 300 of the website of the online banking may verify the authentication information transmitted from the first terminal 100 or the second terminal 200 and approve the authentication of the account transfer requested by the user.

The second terminal 200 according to the exemplary embodiment may include wearable electronic devices including a smart watch, a smart glass, an electronic bracelet, an electronic anklet, an electronic necklace, an electronic ring, an electronic belt, and the like, a notebook computer, a cellular phone, a smart phone, a tablet, personal digital assistants (PDA), a portable multimedia player (PMP), a digital broadcasting terminal, a portable game terminal, a navigation system, and the like.

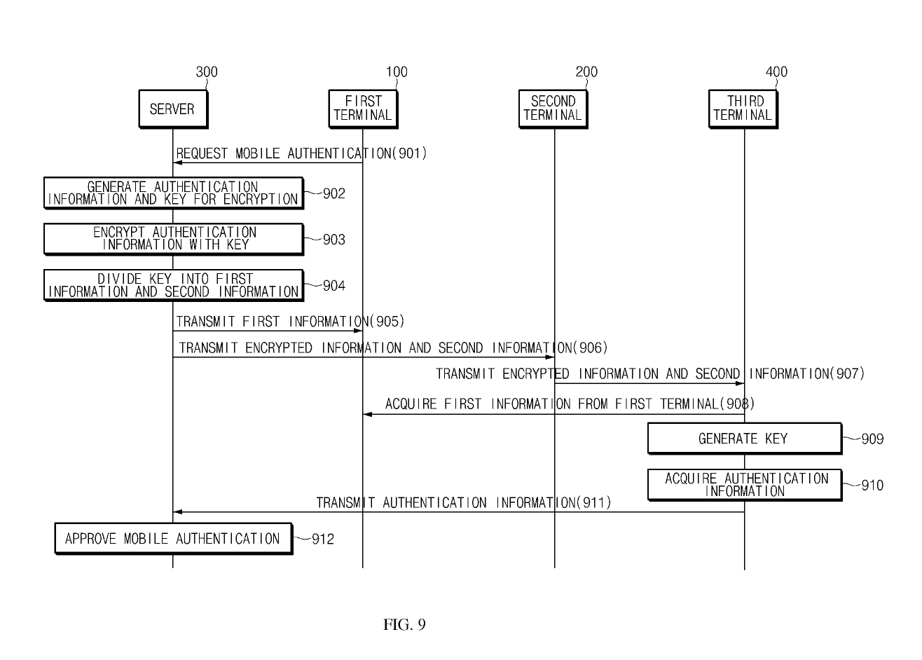

FIG. 8 is a flowchart for describing a method for security authentication via a mobile device according to an exemplary embodiment of the present invention. The flowchart illustrated in FIG. 8 is constituted by processes, in time series, processed in the system for security authentication via a mobile device illustrated in FIG. 1. Accordingly, it may be known that even though skipped hereinbelow, the above description of the system for security authentication via a mobile device illustrated in FIG. 1 may also be applied to the flowchart illustrated in FIG. 8.

In step 801, the first terminal 100 may transmit the request for the mobile authentication of the user to the server 300. For example, the mobile authentication may include personal verification, a transaction approval, or security authentication such as in services including joining a website, an account transfer, micropayment system, signing in to a website (log-in), and the like.

In step 802, the server 300 may generate the authentication information and the encryption key in response to the user's request. For example, the server 300 may generate the encryption key for the authentication information whenever the authentication information is requested.

In step 803, the server 300 may encrypt the authentication information with the generated key. For example, the server 300 further encrypts the authentication purpose or the server information in addition to the authentication information.

In step 804, the server 300 may divide the key into first information and second information.

In step 805, the server 300 may transmit the first information to the first terminal 100.

In step 806, the server 300 may transmit the encrypted information and the second information to the second terminal 200. For example, the server 300 may transmit the encrypted information and the second information by using Internet connection with the second terminal 200, a short message service (SMS) message, a multimedia message service (MMS) message, and a PUSH notification.

In step 807, the second terminal 200 may acquire the first information from the first terminal 100. For example the second terminal 200 may acquire the first information from the first terminal 100 by using camera photographing, a near field communication (NFC) touch, a Bluetooth connection button click, or a WiFi connection button click.

In step 808, the second terminal 200 may generate the key based on the first information and the second information of the key.

In step 809, the second terminal 200 may acquire the authentication information by using the generated key. According to an exemplary embodiment, when the encrypted information includes the server information or the authentication purpose, the second terminal 200 may acquire the server information or the authentication purpose together with the authentication information. For example, the second terminal 200 may display the authentication information or the authentication purpose on the screen.

In step 810, the second terminal 200 may transmit the acquired the authentication information to the server 300. For example the second terminal 200 may transmit the authentication information to the server 300 by using the server information when the user verifies the authentication information or the authentication purpose.

In step 811, the server 300 may approve the mobile authentication.

FIG. 9 is a flowchart for describing a method for security authentication via a mobile device according to an exemplary embodiment of the present invention. The flowchart illustrated in FIG. 9 is constituted by processes, in time series, processed in the mobile authentication system illustrated in FIG. 2. Accordingly, it may be known that even though skipped hereinbelow, the above description of the system for security authentication via a mobile device illustrated in FIG. 2 may also be applied to the flowchart illustrated in FIG. 9.

In step 901, the first terminal 100 may transmit the request for the mobile authentication of the user to the server 300. For example, the mobile authentication may include personal verification, a transaction approval, or security authentication such as in services including joining a website, an account transfer, micropayment system, signing in to a website (log-in), and the like.

In step 902, the server 300 may generate the authentication information and the encryption key in response to the user's request. For example, the server 300 may generate the encryption key for the authentication information whenever the authentication information is requested.

In step 903, the server 300 may encrypt the authentication information with the generated key. For example, the server 300 further encrypts the authentication purpose or the server information in addition to the authentication information.

In step 904, the server 300 may divide the key into first information and second information.

In step 905, the server 300 may transmit the first information to the first terminal 100.

In step 906, the server 300 may transmit the encrypted information and the second information to the third terminal 400. For example, the server 300 may transmit the encrypted information and the second information by using Internet connection with the third terminal 400, a short message service (SMS) message, a multimedia message service (MMS) message, and a PUSH notification.

In step 907, the third terminal 400 may transmit the encrypted information and the second information to the second terminal 200. For example, the third terminal 400 may transmit the encrypted information and the second information to the second terminal 200 through near field communication (NFC), Bluetooth, or WiFi.

In step 908, the second terminal 200 may acquire the first information from the first terminal 100. For example, the second terminal 200 may acquire the first information from the first terminal 100 by using the camera photographing, a near field communication (NFC) touch, a Bluetooth connection button click, or a WiFi connection button click.

In step 909, the second terminal 200 may generate the key based on the first information and the second information of the key. For example, the second terminal 200 may transmit the authentication information to the server 300 when the user verifies the authentication information or the authentication purpose.

In step 910, the second terminal 200 may acquire the authentication information by using the generated key. For example, the second terminal 200 may further acquire the server information or the authentication purpose together with the authentication information.

In step 911, the second terminal 200 may transmit the acquired authentication information to the server 300. For example, the second terminal 200 may transmit the authentication information to the server 300 by using the server information when the user verifies the authentication information or the authentication purpose.

In step 912, the server 300 may approve the mobile authentication.

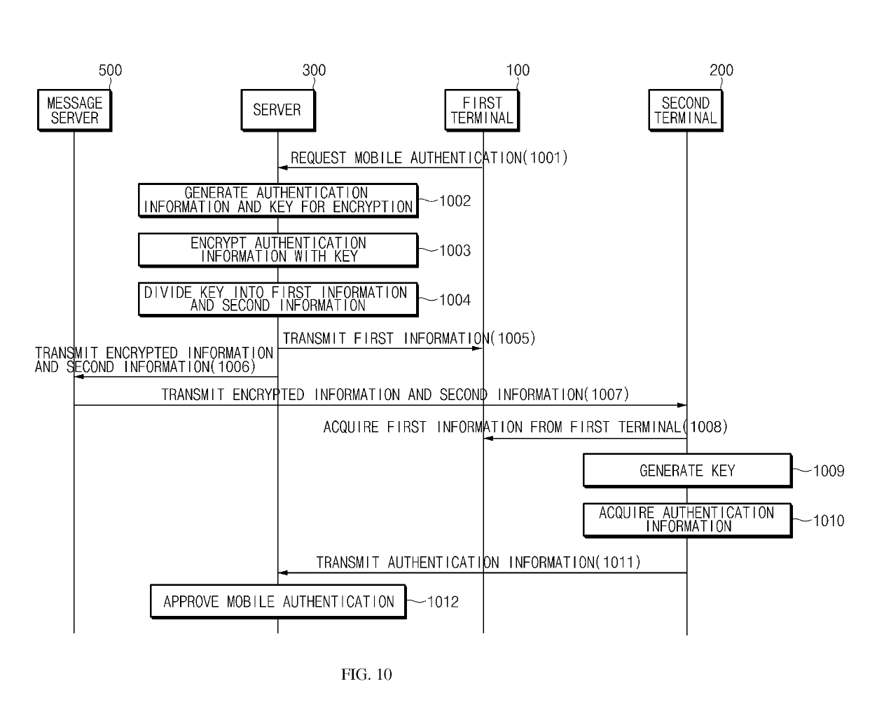

FIG. 10 is a flowchart for describing a method for security authentication via a mobile device according to an exemplary embodiment of the present invention. The flowchart illustrated in FIG. 10 is constituted by processes, in time series, processed in the mobile authentication system illustrated in FIG. 3. Accordingly, it may be known that even though skipped hereinbelow, the above description of the system for security authentication via a mobile device illustrated in FIG. 3 may also be applied to the flowchart illustrated in FIG. 10.

In step 1001, the first terminal 100 may transmit the request for the mobile authentication of the user to the server 300. According to an exemplary embodiment, the first terminal 100 further includes the identification information to transmit the corresponding information.

In step 1002, the server 300 may generate the authentication information and the encryption key in response to the user's request. For example, the server 300 may generate the encryption key for the authentication information whenever the authentication information is requested.

In step 1003, the server 300 may encrypt the authentication information with the generated key. For example, the server 300 further encrypts the authentication purpose or the server information in addition to the authentication information.

In step 1004, the server 300 may divide the key into first information and second information.

In step 1005, the server 300 may transmit the first information to the first terminal 100.

In step 1006, the server 300 may transmit the identification information, the encrypted information, and the second information to the message server 500.

In step 1007, the message server 500 may transmit the encrypted information and the second information to the second terminal 200 by using the identification information. For example, the server 300 may transmit the encrypted information and the second information by using Internet connection with the third terminal 400, a short message service (SMS) message, a multimedia message service (MMS) message, and a PUSH notification.

In step 1008, the second terminal 200 may acquire the first information from the first terminal 100. For example, the second terminal 200 may acquire the first information from the first terminal 100 by using camera photographing, a near field communication (NFC) touch, a Bluetooth connection button click, or a WiFi connection button click.

In step 1009, the second terminal 200 may generate the key based on the first information and the second information.

In step 1010, the second terminal 200 may acquire the authentication information by using the generated key. For example, the second terminal 200 may acquire the server information or the authentication purpose together with the authentication information.

In step 1011, the second terminal 200 may transmit the acquired authentication information to the server 300. The second terminal 200 may transmit the authentication information to the server 300 by using the server information when the user verifies the authentication information or the authentication purpose.

In step 1012, the server 300 may approve the mobile authentication.

According to exemplary embodiments of the present invention, a system and a method for security authentication via a mobile device may divide a key and transmit divided information of the key to an authentication-information-request-terminal and an authentication-information-receiving-terminal, so as to prevent all of the key from being exposed even though any one terminal is attacked by phishing or a vicious code, or information is intercepted by a vicious web, and the like.

A server may generate authentication information and a key for encryption whenever the authentication information is requested to transfer the authentication information and the key to a terminal of the user, so as to prevent the key from exposing, which is caused by registering and managing the key between the server and the terminal.

The system and the method for security authentication via a mobile device may acquire the key through organic interaction between the authentication-information-receiving-terminal and the authentication-information-request-terminal, so as to strengthen the security of authentication.

The steps of the method or algorithm explained in connection with the disclosed embodiments may be directly implemented in hardware, a software module, or the combination of both, executed by a processor. The software module may reside in a RAM memory, a flash memory, a ROM memory, an EPROM memory, an EEPROM memory, a register, a hard disk, a removable disk, a CD-ROM, or a storage medium of any other form known in the art. An exemplary storage medium is coupled to a processor, the processor may read information from the storage medium and write information in the storage medium. In the alternative, the storage medium ma by integral to the processor. The processor and the storage medium may be resided in an application specific integrated circuit (ASIC). ASIC may reside in a user terminal. In the alternative, the processor and the storage medium may reside as discrete components in a user.

All embodiments and conditional examples disclosed in this specification are just for describing by way of examples thereof in order to help that ordinary skill in the art understand the principle and concept of the present invention, and it will be understood by those skilled in the art that the present invention may be implemented as various modifications with departing from the spirit of the present invention. Therefore, the disclosed embodiments must be considered not as a view of limitation but as a view of description. The scope of the present invention is recited in the appended claims, not the above descriptions, and all differences within the equivalent scope of the present invention will be construed as being included in the present invention.

What is claimed is:

1. A system for security authentication via a mobile device, comprising:
a first terminal of a user configured to request mobile authentication;
a server configured to generate authentication information and a key for encryption in response to the request for the mobile authentication, encrypt the authentication information with the key, and divide the key into first information and second information to transmit the first information to the first terminal and transmit the second information and the encrypted information to a second terminal of the user different from the first terminal; and
the second terminal of the user configured to acquire the first information from the first terminal, generate the key based on the first information and the second information, and acquires the authentication information by using the generated key.

2. The system of claim 1, further comprising:
a third terminal configured to perform short-range wireless communication with the second terminal,
wherein the server transmits the second information and the encrypted information to the third terminal, and
the second terminal receives the second information and the encrypted information from the third terminal.

3. The system of claim 2, wherein the second terminal is connected to the third terminal, and
the third terminal transfers the second information and the encrypted information to the second terminal through near field communication (NFC), Bluetooth, or WiFi when receiving the second information and the encrypted information from the server.

4. The system of claim 1, further comprising:
a message server configured to transmit the second information and the encrypted information to the second terminal based on identification information received from the server,
wherein the server transmits the second information and the encrypted information to the second terminal through the message server.

5. The system of claim 1, wherein the encrypted information further includes server information, and
the second terminal acquires the server information together with the authentication information by using the generated key and transmits the authentication information to the server by using the server information.

6. The system of claim 1, wherein the encrypted information further includes an authentication purpose, and
the second terminal acquires the authentication purpose together with the authentication information by using the generated key and displays the authentication information and the authentication purpose on a screen.

7. The system of claim 1, wherein the encrypted information further includes an authentication purpose, and
the second terminal acquires the authentication purpose together with the authentication information by using the generated key, displays the authentication purpose on a screen, and transmits the authentication information to the server when the user verifies the authentication purpose.

8. The system of claim 1, wherein the second terminal acquires the first information from the first terminal by using at least one of camera photographing, a near field communication (NFC) touch, a Bluetooth connection button click, and a WiFi connection button click.

9. The system of claim 1, wherein the first terminal displays the first information received from the server on a screen in a quick response code (QR code) or bar code format, and
the second terminal reads the QR code or barcode displayed on the screen of the first terminal by using a camera to acquire the first information.

10. The system of claim 1, wherein the server transmits the second information and the encrypted information to the second terminal by using at least one of Internet connection with the second terminal, a short message service (SMS), a multimedia message service (MMS), and push notification.

11. A method for security authentication via a mobile device, comprising:
receiving, by a server performing mobile authentication, a request for mobile authentication from a first terminal of a user;
generating, by the server, authentication information and a key for encryption in response to the request for the mobile authentication;
encrypting, by the server, the authentication information with the key;
dividing, by the server, the key into first information and second information;
transmitting, by the server, the first information to the first terminal; and
transmitting, by the server, the second information and the encrypted information to a second terminal of the user different from the first terminal.

12. The method of claim 11, further comprising:
receiving the authentication information from the second terminal; and
approving the request for mobile authentication of the first terminal based on the received authentication information,
wherein the second terminal acquires the received authentication information by the key generated by the second terminal based on information received from the server and the first terminal.

13. The method of claim 11, further comprising:
receiving authentication information from a third terminal of the user different from the first terminal and the second terminal; and
approving the request for mobile authentication of the first terminal based on the received authentication information,
wherein the third terminal acquires the received authentication information by the key generated by the third terminal based on information received from the first terminal and the second terminal.

14. The method of claim 11, further comprising:
receiving identification information from the first terminal; and
transmitting the identification information to a message server,
wherein in the transmitting of the second information and the encrypted information,
the second information and the encrypted information are transmitted to the second terminal through the message server.

15. The method of claim 11, wherein in the encrypting, at least one of server information and an authentication purpose is encrypted together with the authentication information by using the key.

16. A method for security authentication via a mobile device, comprising:
receiving, by a second terminal of a user, encrypted information and second information of a key for encryption from a server;
acquiring, by the second terminal, first information of the key from a first terminal of the user which requests the server for mobile authentication;
generating, by the second terminal, the key based on the first information and the second information;
acquiring, by the second terminal, the authentication information by decrypting the encrypted information using the key; and
transmitting, by the second terminal, the acquired authentication information to the server.

17. The method of claim 16, further comprising:
displaying an authentication purpose on a screen,
wherein the encrypted information is acquired by encrypting the authentication information and the authentication purpose,
in the acquiring of the authentication information,
the authentication purpose is acquired together with the authentication information by using the generated key, and
in the transmitting of the authentication information,
when the user verifies the authentication purpose, the authentication information is transmitted to the server.

18. The method of claim 16, wherein the encrypted information is acquired by encrypting the authentication information and server information, in the acquiring of the authentication information,
the server information is acquired together with the authentication information by using the generated key, and
in the transmitting of the authentication information,
the authentication information is transmitted to the server by using the server information.

19. The method of claim 16, wherein in the acquiring of the first information, a QR code or a barcode displayed on a screen of the first terminal is read to acquire the first information from the first terminal.

20. The method of claim 16, wherein in the receiving, the second information and the encrypted information are received from the server by using at least one of Internet connection with the server, a short message service (SMS), a multimedia message service (MMS), and push notification.
